(19) United States
(12) Patent Application Publication
(10) Pub. No.: US 2010/0313694 A1
(43) Pub. Date: Dec. 16, 2010

(54) APPARATUS FOR HOLDING CABLES IN ROTARY SHAFT OF ROBOT

(75) Inventor: Akira AOKI, Kariya-shi (JP)

Correspondence Address: OLIFF & BERRIDGE, PLC, P.O. BOX 320850, ALEXANDRIA, VA, 22320-4850, US

(73) Assignee: DENSO WAVE INCORPORATED, TOKYO (JP)

(21) Appl. No.: 12/814,679

(22) Filed: Jun. 14, 2010

(30) Foreign Application Priority Data
Jun. 15, 2009 (JP) 2009-142306

(51) Int. Cl. B25J 18/00

(52) U.S. Cl. 74/490.02

(57) ABSTRACT

An apparatus holds plural cables arranged in a robot. A first fixing member secures ones of both ends of the cables on a first shaft portion in a flat form, the ones of the end portions being directed in a rotation direction of the second shaft portion. A second fixing member secures the others of both end portions of the cables on a second shaft portion in the flat form, the other end portions being directed in the rotation direction. The remaining portions of the cables are bent and suspended along the first and second shaft portions in a U-shaped and flat form when being viewed in the rotation direction. A first cable guide, fixed to the first shaft portion, accommodates part of the cables therein in the plat form. A second cable guide, fixed to the second shaft portion, accommodates part of the cables therein in the flat form.

### CROSS-REFERENCE TO RELATED APPLICATION

This application is based on and claims the benefit of priority from earlier Japanese Patent Application No. 2009-142306 filed Jun. 15, 2009, the description of which is incorporated herein by reference.

### BACKGROUND OF THE INVENTION

1. Technical Field of the Invention

The present invention relates to an apparatus for holding cables in arms of an articulated type of robot, and in particular, to the apparatus that holds the cables bridging a fixed part and a rotary part in the arms.

2. Related Art

A robot having an articulated arm includes motors and joints. The motors are located at the axes of the respective joints to actuate the joints. Such a robot is controlled by a controller with the supply of electric power to the motors. Therefore, the controller and the robot are connected via cables. Generally, such cables are bundled up. Also, such cables are usually accommodated inside the robot and connected to respective parts from the inside, in order to save space or avoid the cables per se from becoming a hindrance.

However, under the conditions as described above, rotation of the robot arm may cause the cables to be in contact with the members producing the rotation (rotating members), and may create friction between the rotating members and the cables. In particular, the friction created between the rotating members and the cables is liable to increase when the overall structure of the robot is made compact, because in such a compact structure the cables are pressed against the rotating members. The increase of friction may disable smooth rotational movement of the arm. As a result, the movement of the arm may become sluggish, or rotation per se of the rotating members may be disabled. For example, JP-A-2006-187841 discloses that rotating members of a robot are prevented from contacting with cables by arranging the cables outside the robot and providing members that restrict the movement of the cables.

The configuration disclosed in JP-A-2006-187841 is able to prevent the Interference between the shaft located on a tip end side of the arm and the cables to effectively reduce friction. In return, however, this configuration necessitates external routing of the cables, i.e. routing of the cables outside the robot. Therefore, the space occupied by the robot is increased by an amount corresponding to the space required for the external routing of the cables. For this reason, the external routing of cables cannot be applied to those robots which are required to be contributory to space saving.

### SUMMARY OF THE INVENTION

The present invention has been made in light of the circumstances set forth above, and has as its object to provide a cable holding structure for a rotary shaft of a robot, which structure is able to save space in arranging cables and prevent, as much as possible, friction between each of the cables and each of the members that produce rotation.

According to a cable holding structure for a rotary shaft of a robot based on one aspect of the present invention, a plurality of cables are arranged flat along an outer peripheral portion of a rotary shaft. Therefore, when a rotary part starts rotational movement, one tip end of each group of cables (hereinafter referred to as “cable group”) starts moving with the rotational movement. Meanwhile, other portion of the cable group, which is in a state of being bent into a U-shape, follows the rotational movement along the outer peripheral portion. At this moment, the U-shaped bent portion (hereinafter referred to as are “R portion”) of the cable group takes a movement in relation to the direction of the rotation, while straight portions of the cable group rotate integrally with the rotary part and rotary cable guides.

In other words, when the rotary shaft starts rotational movement, friction is caused only at the R portion of each cable group. Accordingly, friction can be significantly reduced and thus smooth rotational movement can be ensured. In this way, each cable group can be compactly arranged along the outer peripheral portion of the rotary shaft, saving space and without becoming a hindrance to the rotational movement. In addition, since the load that would be imposed on the cables is reduced, the cables are unlikely to be damaged and thus reliability can be enhanced.

According to a cable holding structure for a rotary shaft of a robot based on another aspect of the present invention, each cable guide has a U-shaped cross section with a predetermined gap and is formed, in its entirety, of a cylindrical member. Specifically, each cable guide has a U-shaped portion by which each flat cable group can be held. Accordingly, similar to the foregoing, when the rotary part starts rotational movement, friction is caused only at the R portion of each cable group. Thus, the same advantages as the foregoing can be obtained.

According to the cable holding structure for a rotary shaft of a robot based on another aspect of the present invention, when the controller and the robot are connected using two cable groups, the two cable groups are fixed such that tip end portions of one cable group are opposed to tip end portions of the other cable group, displaying a bilaterally symmetrical arrangement as a result. With this configuration, in whichever direction the rotary part may rotate, the cable groups can move along the outer peripheral portion without becoming a hindrance to each other's movement In this way, if the number of cables connecting between the controller and the robot is increased, space can be saved without permitting the cables to prevent the rotational movement.

According to the cable holding structure for a rotary shaft of a robot based on another aspect of the present invention, the width of the gap formed by the cable guides is set to be larger than the diameter of each cable by a factor of 1.7 or less. In the event a portion of each cable gravitationally hangs down, the above setting, coupled with the comparatively low flexibility of the cable, can permit the cable at an upper position to stay in a state of its center being deviated outward by 45 degrees or less from the center of the cable at a lower position. In this way, smooth rotational movement can be maintained.

Specifically, let us assume that two cables are vertically in contact with each other and that these cables stay in a state where the center of the upper cable is deviated outward from the center of the lower cable by 45 degrees. The width of the gap suitable for this state can be expressed by:

(1+1/2^{1/2})D≈1.7D,

where D is a diameter of the cable. As a matter of course, the lower limit of the width of the gap should exceed the diameter of each cable.

Still another aspect of the present invention, there is provided an articulated type of robot, comprising: a plurality of articulated arms respectively provided with electric motors to drive the arms, the motors receiving drive signals from a controller, the arms having rotary shaft portions which allow the arms to rotate on axes given thereto, each of the rotary shaft portions being divided into two shaft portions a first of which is fixed and a second of which is rotatable; a plurality of cables electrically connecting the controller and the motors for transmitting the drive signals to the motors; a first fixing member that secures ones of both ends of the cables on and along the first shaft portion in a flat form in which the cables are arranged in parallel with each other, the ones of both end portions of the cables being directed in a rotation direction along which the second shaft portion rotates; a second fixing member that secures the others of both end portions of the cables on and along the second shaft portion in the flat form, the others of both end portions of the cables being directed in the rotation direction so that remaining portions of the cables are bent and suspended along the first and second shaft portions in a U-shaped and flat form when being viewed in the rotation direction; a first cable guide that is fixedly arranged along the first shaft portion and has a circular tube-shaped space therealong in which the cables are partly accommodated in the flat form; and a second cable guide that is arranged along the second shaft portion so as to rotate together with the second shaft portion and has a circular tube-shaped space therealong in which the cables are partly accommodated in the flat form.

### BRIEF DESCRIPTION OF THE DRAWINGS

In the accompanying drawings:

FIG. 1 is a perspective view illustrating the configuration of a vertical articulated robot, according to a first embodiment of the present invention;

FIG. 2A is a perspective view illustrating the inside of a base of the robot;

FIG. 2B is a vertical cross-sectional view illustrating the inside of the base;

FIG. 3 is a diagram illustrating a principle of restricting the width of a gap defined by cable guides in the base;

FIGS. 4A to 4D are diagrams each illustrating the movement of individual cables when a rotary part of the base starts rotation;

FIG. 5 is a diagram illustrating a cable-routing structure of the conventional art, in a manner analogous to FIG. 2B; and

FIG. 6 is a cross-sectional view illustrating the inside of the base so of a robot, according to a second embodiment of the present invention.

### DETAILED DESCRIPTION OF THE PREFERRED EMBODIMENTS

With reference to the accompanying drawings, hereinafter are described some embodiments of the present invention.

### First Embodiment

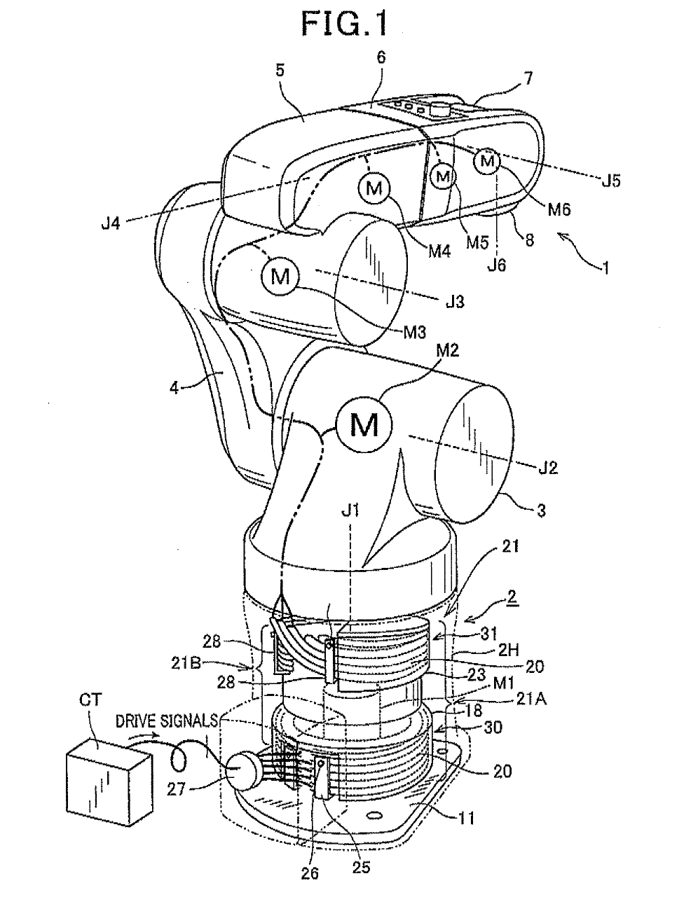

With reference to FIGS. 1 to 5, hereinafter is described a first embodiment of the present invention. FIG. 1 is a perspective view illustrating the configuration of a vertical articulated (six-axis) robot 1 according to the first embodiment. The robot 1 includes a base (functioning as one of rotary shaft portions) 2 on which an arm, a six-axis arm in this case, is provided. The base 2 includes a housing 2H and a substantially rectangular bottom plate 11. The arm has a tip end to which a tool, such as a hand, not shown, is attached. Specifically, the arm includes first, second, third, fourth, fifth and sixth joints J1, J2, J3, J4, J5 and J6, and first, second, third, fourth, fifth and sixth arms 3, 4, 5, 6, 7 and 8, as well as servomotors M1 to M6. The is first arm 3 is rotatably connected onto the base 2 via the first joint J1. The second arm 4 extending upward has a lower end portion which is rotatably connected to the first arm 3 via the second joint J2. The second arm 4 has a tip end portion to which the third arm 5 is rotatably connected via the third joint J3.

The third arm 5 has a tip end to which the fourth arm 6 is rotatably connected via the fourth joint J4. The fourth arm 6 has a tip end to which the fifth arm 7 is rotatably connected via the fifth joint J5. The sixth arm 8 is rotatably connected to the fifth arm 7 via the sixth joint J6. The arms 3 to 8 are adapted to be rotated and actuated by the servomotors M1 to M6 located in the respective joints J1 to J6.

The present invention is characterized in the structure with which the cables can be arranged inside the base 2 (inside the housing 2H), the cables connecting the servomotors M1 to M6 in the robot 1 to a controller (control unit) CT. The controller CT sends out drive signal to the motors M1 to M6 to drive rotation of those motors.

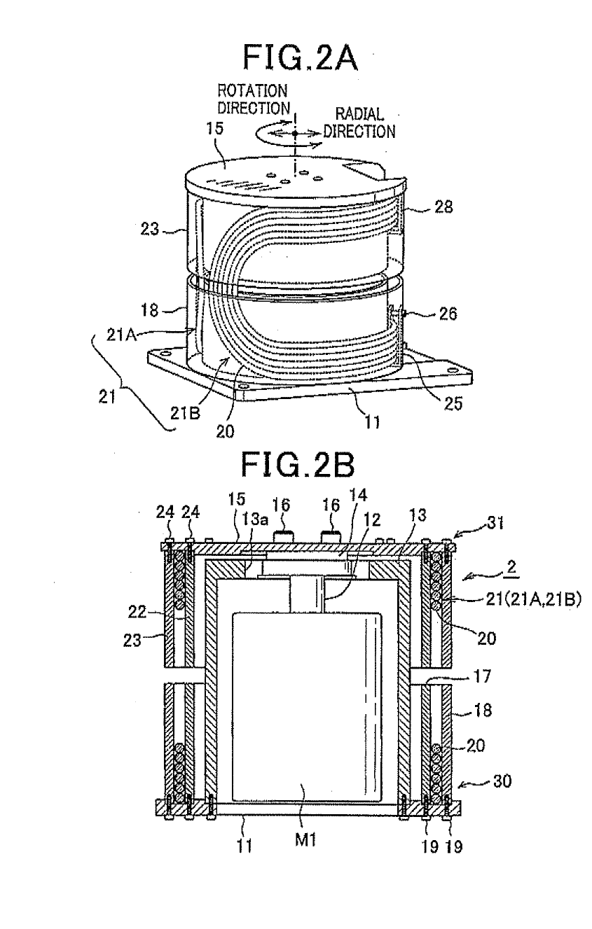

FIG. 2A is a perspective view illustrating the inside of the base 2 of the robot 1, with the housing 2H being removed. FIG. 2B is a vertical cross-sectional view illustrating the inside of the base 2, with the housing 2H being removed. The base 2 includes therein the servomotor M1, a rotary shaft 12, a cylindrical motor cover 13 having an opening 13a, a disc-shaped attachment member 14, a substantially disc-shaped top plate 15, bolts 16, stationary cable guides 17 and 18, bolts 19, cables 20 forming each group 21 (21A or 21B) of cables (hereinafter represented as a “cable group 21”), rotary cable guides 22 and 23, and bolts 24.

The servomotor M1 is disposed at the center of the substantially rectangular bottom plate 11 such that the rotary shaft 12 of the servomotor M1 is directed upward. The motor cover 13 is disposed enclosing the outer peripheral portion of the body of the servomotor M1 with a predetermined space therebetween. The opening 13a is provided at an upper part of the motor cover 13. The rotary shaft 12 has a tip end to which the disc-like attachment member 14 is fixed. The diameter of the attachment member 14 is set to be smaller than that of the opening 13a. The substantially disc-like top plate 15 is attached to the attachment member 14, being screwed therein via the bolts 16. The arm 3 is fixedly mounted on the top plate 15, for rotation around the joint J1.

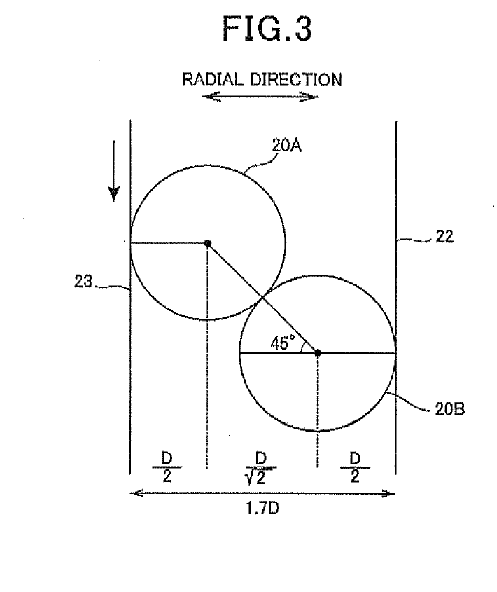

The motor cover 13 has a lower half portion which is covered by the stationary cable guides 17 and 18 each having a cylindrical shape. In covering the motor cover 13, the stationary cable guides 17 and 18 are coaxially and doubly arranged, being screwed from the side of the bottom plate 11 using the bolts 19. The stationary cable guides 17 and 18 are arranged with a predetermined gap therebetween. In the gap, a plurality of cables 20 are flatly juxtaposed forming one of the cable groups 21. Specifically, the gap between the stationary cable guides 17 and 18 is set to be slightly larger than the diameter of each cable 20 (see FIG. 3 described later).

The motor cover 13 has an upper half portion which is covered by the rotary cable guides 22 and 23 each having a cylindrical shape. In covering the motor cover 13, the rotary cable guides 22 and 23 are coaxially and doubly arranged being screwed from the side of the top plate 15 using the bolts 24. The cable guides 22 and 23 are positioned so as to be symmetrical to the stationary cable guides 17 and 18. The rotary cable guides 22 and 23 are ensured to face the stationary cable guides 17 and 18 through a predetermined space. As shown in FIG. 1, these cable guides 17, 18, 22 and 23 are externally covered by the housing 2H of the base 2.

As shown in FIG. 1, the stationary cable guide 18 arranged outside has a front portion in which a cut-off portion is provided. In the cut-off portion, cable-lower-end fixing members 25, each made up, for example, of a U-shaped steel member, are fixedly screwed, at upper ends of the respective members 25, into the stationary cable guide 17 via bolts 26. Each cable group 21 has a portion at a lower end (one tip end), which portion is adapted to extend from the cable-lower-end fixing members 25 to the outside of the base 2 and be connected to a connector 27 and then, via the connector 27, to the controller CT.

As shown in FIG. 2A, each cable group 21, with its lower end being maintained flat, and in a state of being fixed by the cable-lower-end fixing members 25, is extended straight along the stationary cable guide 17. Then, this cable group 21 is turned back, drawing a shape of U (i.e. providing a U-shaped bent portion), in the direction in which the cables 20 are juxtaposed, and directed to the gap between the rotary cable guides 22 and 23. Each cable group 21 is then extended straight again in a direction reverse to the direction in which the cable group 21 has been extended between the stationary cable guides 17 and 18. Thus, an upper end (the other tip end) of each cable group 21 arrives at a position above the cable-lower-end fixing members 25.

Each cable group 21, with its upper end also being maintained flat, is fixed at the above arrival position by cable-upper-end fixing members 28 each having a configuration similar to the cable-lower-end fixing member 25. The cable-upper-end fixing members 28 are screwed in and fixed to the rotary cable guide 22 located inside, using respective bolts 29 (see FIG. 1). From there, the upper end of each cable group 21 is extended upward and inserted into the respective arms 3 to 7 of the robot 1, so that tip ends of the cables 20 are connected to the respective servomotors M1 to M6 and the like.

In the configuration of the present embodiment, as shown in FIGS. 1 and 2A, two cable groups 21 (i.e., 21A and 21B) are arranged. Specifically, the two cable groups 21 are arranged so that the upper ends as well as the lower ends of the cable groups 21 are opposed to each other, displaying a bilaterally symmetrical arrangement. In other words, as can be seen from FIG. 2A, outer portions of the U-shaped bent portions (hereinafter each referred to as an “R portion”) of the respective cable groups 21 are opposed to each other.

It should be appreciated that the cables 20 are not necessarily restrictively used for electric wiring. The cables 20 may include, for example, those which convey compressed air or those which suck air, liquid or materials for performing vacuum adsorption.

In the base 2 described above, the housing 211, the bottom plate 11, the motor cover 13, and the stationary cable guides 17 and 18 configure a stationary part 30. Meanwhile, the top plate 15, and the rotary cable guides 22 and 23 configure a rotary part 31.

FIG. 3 is a diagram illustrating a principle of restricting the width of the gap between the stationary cable guides 17 and 18, and between the rotary cable guides 22 and 23. Specifically, FIG. 3 schematically illustrates the rotary cable guides 22 and 23 and cross sections of two cables 20A and 20B located therebetween. FIG. 3 shows a state where the center of the cable 20A at an upper position is deviated outward by 45 degrees from the center of the cable 20B at a lower position.

More specifically, as shown in FIG. 3, when the width of the gap between the rotary cable guides 22 and 23 is set larger than a diameter D of the cable 20, the cable 20A at the upper position is expected to be deviated outward. As will be described later, it is desirable that the flatness of the cable groups 21 is maintained when the arm 3 is rotated relative to the base 2. Appropriate setting of an upper limit in the width of the gap can prevent excessive derailing (deviation) of the cable 20A at the upper position. In FIG. 3, the outward deviation of the center of the cable 20A at the upper position is ensured to be restricted to less than 45 degrees. The angle of 45 degrees is a limit that allows the cables to move. When the deviation is exactly 45 degrees, the width of the gap between the rotary cable guides 22 and 23 is expressed by;

(D/2)×2+D/2^{1/2}=(1+/2^{1/2})D1.7D,

where D is a diameter of the cable 20. Accordingly, it may be appropriate to set the width of the gap to be larger than the diameter of the cable 20 by a factor of 1.7 or less (e.g., by a factor of 1.5).

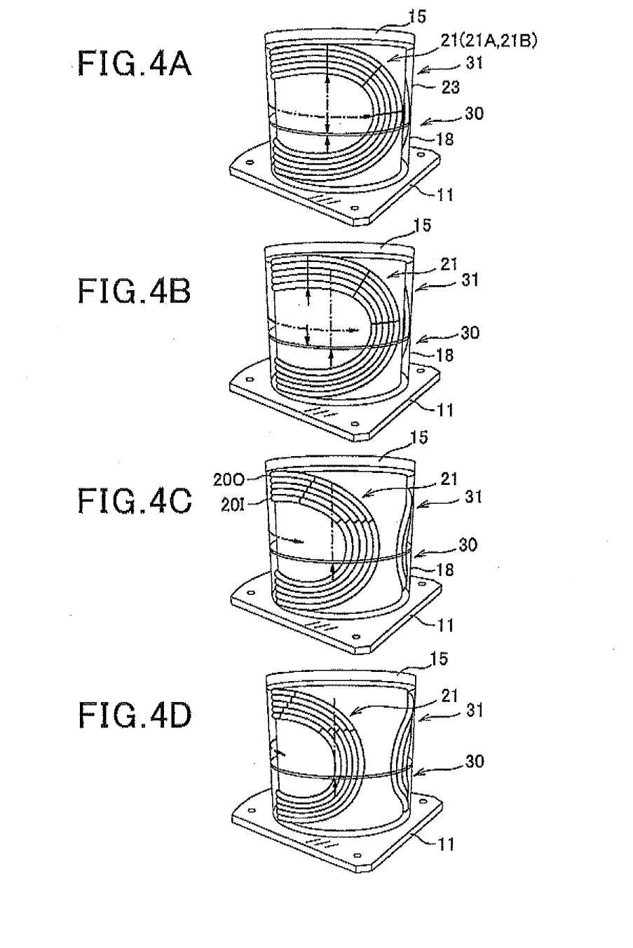

Referring now to FIGS. 4A to 4D, advantages of the present embodiment will be explained. FIGS. 4A to 4D are diagrams each illustrating the movement of the individual cables 20 when the rotary part 31 of the base 2 is rotated. Specifically, FIGS. 4A to 4D each illustrate the movement of each cable group 21 (i.e., 21A or 21B) when the rotary part 31 of the base 2 is rotated from an initial state shown in FIG. 4A, where the upper and lower ends of each cable group 21 are vertically positioned. The illustrations are given each focusing on the U-shaped R portion of each cable group 21. In FIGS. 4A to 4D, the cable guides 17, 18, 22 and 23 are made experimentally transparent for observation.

At an initial position indicated by the vertical dashed line in FIG. 4A, the stationary cable guide 18 and the rotary cable guide 23 are marked with up and down arrows, respectively, such that the tip ends of the arrows coincide. The cables 20 inside forming each cable group 21 are marked with straight lines. The rotary cable guide 23 is also marked with a right arrow such that the tip end of the right arrow coincides with a horizontal line marked at the R portion of the cable group 21, the horizontal line being one of the straight lines marked on the cable group 21.

From this state, the rotary part 31 on the side of the top plate 15 is rotated clockwise (CW) as viewed from the top. Then, as shown in FIG. 4B, the down arrow of the rotary cable guide 23 moves leftward in the figure. With this movement, the upper end of the cable group 21 is pulled leftward in the figure, allowing the R portion to entirely move leftward. Further, the horizontal line marked at the R portion moves upward relative to the right arrow marked on the rotary cable guide 23.

As shown in FIG. 4C, with further clockwise rotation of the rotary part 31, the right arrow of the rotary cable guide 23 moves leftward relative to the vertical dashed line indicating the initial position, while the R portion of each cable group 21 comes closer to the dashed line. In the R portion, an amount of movement appears to be larger in a cable 201 located innermost of the cable group 21 than in a cable 200 located outermost of the cable group 21. Specifically, the amount of movement appears to be different cable by cable, or more specifically, appears to increase as the cable is located more inside. As a result of the different amount of movement of the individual cables 20, the horizontal line, which has coincided with the right arrow in the initial state shown in FIG. 4A, has turned into a staircase pattern.

As shown in FIG. 4D, with further clockwise rotation of the rotary part 31, the above tendency of drawing a staircase pattern becomes more apparent. As can be seen, the rear end of the R portion of another cable group 21 has appeared from behind, i.e. from the right in the figure, with the rotation. It should be appreciated that the range of clockwise and counterclockwise (CCW) rotation of the rotary part 31 is so set, for example, to be about ±170 degrees.

With this range of rotation, each cable group 21, when it is bent in the shape of U with the rotation of the rotary part 31, can follow the movement of the rotary part 31, maintaining the flatness.

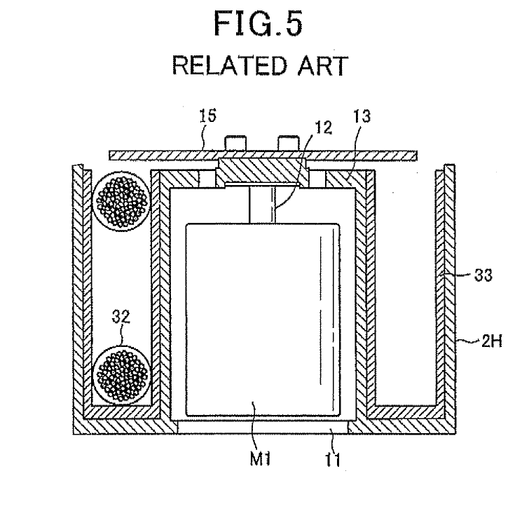

Far comparison, FIG. 5 illustrates a cable-routing structure of the conventional art, in a manner analogous to FIG. 2B. In FIG. 5, the components identical with or similar to those of FIG. 2B (present embodiment) are given the same reference numerals. As shown in FIG. 5, a cable 32 in the conventional art is a thick single cable in which individual lines a bundled together. In a space formed between the motor cover 13 and the housing 2H of the base 2, only a cable guide 33 is provided. The cable guide 33 corresponds to the stationary cable guides 17 and 18 of the present embodiment. The cable 32 is bent drawing a sideways U shape, not shown. When a rotary part including the top plate 15 is rotated, permitting the upper end of the cable 32 to follow the rotation, a large amount of friction is caused between the cable 32 and the cable guide 33 in a fixed state.

In this regard, in the configuration of the present embodiment, the plurality of thin cables 20 are flatly bundled to provide each cable group 21. Each cable group 21 is arranged along the motor cover 13 of the base 2 to reduce the horizontal space occupied by the cable group 21 in the base 2. Thus, since the rotary cable guides 22 and 23 are rotated integrally with the rotation of the rotary part 31, the friction caused when the upper end of the cable group 21 follows the rotation is considerably reduced.

According to the present embodiment described so far, the plurality of cables 20 are flatly arranged in the base 2 along the stationary cable guide 17 and the rotary cable guide 22 (these correspond to the “outer peripheral portion of the rotary part”). When the rotary part 31 starts rotational movement, the upper end of each cable group 21 is permitted to move along the outer periphery of the rotary cable guide 22 to follow the rotational movement, in a state of so being bent in a shape of U. At this moment, the R portion of the cable group 21 takes a movement in relation to the direction of the rotational movement. In this case, the straight portion of the cable group 21, i.e. the portion held by the rotary cable guides 22 and 23, rotates integrally with the rotary part 31 and the rotary cable guides 22 and 23.

In other words, the rotational movement of the base 2 causes friction only at the R portions of each cable groups 21. Therefore, friction can be significantly reduced, whereby smooth rotation of the base 2 can be ensured. Thus, the cable groups 21 can be compactly arranged inside the base 2, along the outer peripheries of the stationary cable guide 17 and the rotary cable guide 22, saving space and without becoming a hindrance to the rotational movement. In addition, since the load that would be imposed on the cables 20 can be reduced, the cables are unlikely to be damaged and thus reliability can be enhanced.

In the present embodiment, when the controller CT and the robot 1 are connected via two cable groups 21, these two cable groups 21 are fixed such that the tip end portions of one cable group 21 as well as the tip end portions of the other cable group 21 are opposed to each other, displaying a bilaterally symmetrical arrangement as a result. Accordingly, in whichever direction the rotary part 31 may rotate, the cable groups 21 can move along the outer peripheries of the stationary cable guide 17 and the rotary cable guide 22 without becoming a hindrance to each other's movement. In this way, if the number of the cables 20 connecting between the controller CT and the robot 1 is increased, space can be saved without permitting the cables to prevent the rotational movement.

According to the present embodiment, the width, of the gap between the stationary cable guides 17 and 18, and between the rotary cable guides 22 and 23 is set to be larger than the diameter of each cable 20 by a factor 1.7 or less. In the event a portion of each cable 20 gravitationally hangs down, the above setting, coupled with the comparatively low flexibility of the cable 20, can permit the cable 20 at so an upper position to stay in a state of its center being deviated outward by 45 degrees or less from the center of the cable 20 at a lower position. In this way, smooth rotational movement can be maintained.

### Second Embodiment

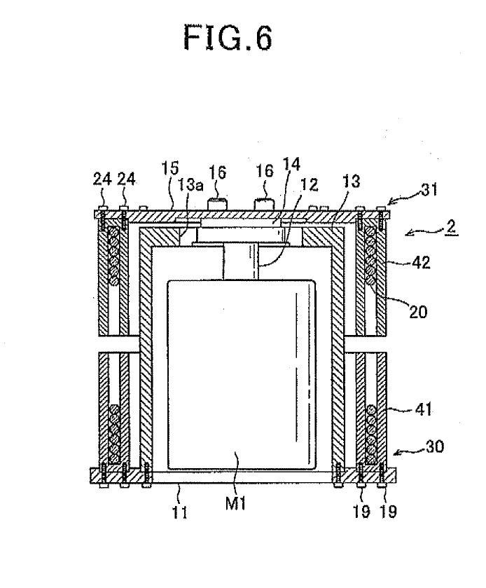

Referring now to FIG. 6, a second embodiment of the present invention is described. In the second embodiment and in the subsequent modifications, the components identical with or similar to those in the first embodiment are given the same reference numerals for the sake of omitting explanation.

FIG. 6 is a cross-sectional view illustrating the inside of the base of a robot, according to the second embodiment. FIG. 6 corresponds to FIG. 2B of the first embodiment. In the second embodiment, a stationary cable guide 41 and a rotary cable guide 42 are provided, replacing the stationary cable guides 17 and 18 and the rotary cable guides 22 and 23. Each of the stationary and rotary cable guides 41 and 42 constitutes a single body and has a U-shaped cross section. Similar to the first embodiment, the width of the gap formed in each of the stationary and rotary cable guides 41 and 42 having a U-shaped cross section is set to be larger than the diameter D of each cable 20 by a factor of 1.7 or less.

According to the second embodiment configured as explained above, the stationary cable guide 41 and the rotary cable guide 42 are each formed of a member having a cylindrical shape in its entirety and having a U-shaped cross section with a predetermined gap. Thus, each cable group 21 can be held by U-shaped portions of the cable guides 41 and 42. Therefore, similar to the first embodiment, when a rotary part 31A starts rotational movement, friction is caused only at the R portions of the cable groups 21, achieving the advantages similar to those in the first embodiment.

(Modifications)

The present invention is not intended to be limited to the embodiments described above and illustrated in the drawings, but may be modified or extended as set forth below.

If cables can be satisfactorily wired with a required number, only one cable group 21 may be arranged. The motor cover 13 may be provided as required. Also, the housing 2H may be removed, allowing the cable guides 18 and 23 located outside to serve as a housing.

Alternatively, a member MC corresponding to the motor cover 13 may be horizontally divided into two, i.e. an upper member MC_U and a lower member MC_D. In this case, the upper member MC_U may be connected to the rotary shaft 12 to serve as a rotary part. Also, the stationary cable guide 18 and the rotary cable guide 23 located outside may be removed to arrange the cable groups 21 each between the lower member MC_D and the stationary cable guide 17 and between the upper member MC_U and the rotary cable guide 22. In this case, the outer periphery of the member MC corresponds to the “outer peripheral portion of the rotary shaft”.

The width of the gap formed in a U-shaped single cable guide or formed between two cable guides may be appropriately changed.

Also, the number of axes of the robot is not limited to six. Further, the present invention may be applied not only to a vertical articulated robot but also to a horizontal articulated robot.

What is claimed is:

1. An apparatus that holds a plurality of cables arranged in a robot with a plurality of articulated arms having rotary shaft portions which allow the arms to rotate on axes given thereto, each of the rotary shaft portions being divided into two shaft portions a first of which is fixed and a second of which is rotatable, the apparatus comprising:
a first fixing member that secures ones of both ends of the cables on and along the first shaft portion in a flat form in which the cables are arranged in parallel with each other, the ones of both end portions of the cables being directed in a rotation direction along which the second shaft portion rotates;
a second fixing member that secures the others of both end portions of the cables on and along the second shaft portion in the flat form, the others of both end portions of the cables being directed in the rotation direction so that remaining portions of the cables are bent and suspended along the first and second shaft portions in a U-shaped and flat form when being viewed in the rotation direction;
a first cable guide that is fixedly arranged along the first shaft portion and has a circular tube-shaped space therealong in which the cables are partly accommodated in the flat form; and
a second cable guide that is fixedly arranged along the second shaft portion so as to rotate together with the second shaft portion and has a circular tube-shaped space therealong in which the cables are partly accommodated in the flat form.

2. The apparatus of claim 1, wherein the first cable guide is structured as a single member formed to have the circular tube-shaped space having a U-shaped section whose one end opposed to the second shaft portion is opened and the second cable guide is structured as a single member formed to have the circular tube-shaped space having a U-shaped section whose one end opposed to the first shaft portion is opened, the U-shaped section being viewed along a radial direction of the rotary shaft portion.

3. The apparatus of claim 2, wherein the cables are divided into two groups consisting of first and second groups of cables, the ones of both end portions of the first group of cables and the ones of both end portions of the second group of cables being secured on and along the first shaft portion to be opposed to each other in the rotation direction and the others of both end portions of the first group of cables and the others of both end portions of the second group of cables being secured on and along the second shaft portion to be opposed to each other in the rotation direction.

4. The apparatus of claim 3, wherein the circular tube-shaped space has a distance in the radial direction of the rotary shaft portion, the distance being set to an amount less than 1.7 times of a diameter of one of the cables.

5. The apparatus of claim 4, wherein the robot has a controller and a plurality of articulated arms respectively provided with electric motors to drive the arms, the cables electrically connecting the controller and the motors.

6. The apparatus of claim 2, wherein the circular tube-shaped space has a distance in the radial direction of the rotary shaft portion, the distance being set to an amount less than 1.7 times of a diameter of one of the cables.

7. The apparatus of claim 6, wherein the robot has a controller and a plurality of articulated arms respectively provided with electric motors to drive the arms, the cables electrically connecting the controller and the motors.

8. The apparatus of claim 1, wherein the first cable guide is structured by two plate members formed to have the circular tube-shaped space having a U-shaped section whose one end opposed to the second shaft portion is opened and the second cable guide is structured by two plate members formed to have the circular tube-shaped space having a U-shaped section whose one end opposed to the first shaft portion is opened, the U-shaped section being viewed along a radial direction of the rotary shaft portion.

9. The apparatus of claim 8, wherein the cables are divided into two groups consisting of first and second groups of cables, the ones of both end portions of the first group of cables and the ones of both end portions of the second group of cables being secured on and along the first shaft portion to be opposed to each other in the rotation direction and the others of both end portions of the first group of cables and the others of both end portions of the second group of cables being secured on and along the second shaft portion to be opposed to each other in the rotation direction.

10. The apparatus of claim 9, wherein the circular tube-shaped space has a distance in the radial direction of the rotary shaft portion, the distance being set to an amount less than 1.7 times of a diameter of one of the cables.

11. The apparatus of claim 10, wherein the robot has a controller and a plurality of articulated arms respectively provided with electric motors to drive the arms, the cables electrically connecting the controller and the motors.

12. The apparatus of claim 8, wherein the circular tube-shaped space has a distance in the radial direction of the rotary shaft portion, the distance being set to an amount less than 1.7 times of a diameter of one of the cables.

13. The apparatus of claim 12, wherein the robot has a controller and a plurality of articulated arms respectively provided with electric motors to drive the arms, the cables electrically connecting the controller and the motors.

14. The apparatus of claim 1, wherein the robot has a controller and a plurality of articulated arms respectively provided with electric motors to drive the arms, the cables electrically connecting the controller and the motors.

15. An articulated type of robot: comprising
a plurality of articulated arms respectively provided with electric motors to drive the arms, the motors receiving drive signals from a controller, the arms having rotary shaft portions which allow the arms to rotate on axes given thereto, each of the rotary shaft portions being divided into two shaft portions a first of which is fixed and a second of which is rotatable;
a plurality of cables electrically connecting the controller and the motors for transmitting the drive signals to the motors;
a first fixing member that secures ones of both ends of the cables on and along the first shaft portion in a flat form in which the cables are arranged in parallel with each other, the ones of both end portions of the cables being directed in a rotation direction along which the second shaft portion rotates;
a second fixing member that secures the others of both end portions of the cables on and along the second shaft portion in the flat form, the others of both end portions of the cables being directed in the rotation direction so that remaining portions of the cables are bent and suspended along the first and second shaft portions in a U-shaped and flat form when being viewed in the rotation direction;
a first cable guide that is fixedly arranged along the first shaft portion and has a circular tube-shaped space therealong in which the cables are partly accommodated in the flat form; and
a second cable guide that is fixedly arranged along the second shaft portion so as to rotate together with the second shaft portion and has a circular tube-shaped space therealong in which the cables are partly accommodated in the flat form.

16. The robot of claim 15, wherein the first cable guide is structured as a single member formed to have the circular tube-shaped space having a U-shaped section whose one end opposed to the second shaft portion is opened and the second cable guide is structured as a single member formed to have the circular tube-shaped space having a U-shaped section whose one end opposed to the first shaft portion is opened, the U-shaped section being viewed along a radial direction of the rotary shaft portion.

17. The robot of claim 16, wherein the cables are divided into two groups consisting of first and second groups of cables, the ones of both end portions of the first group of cables and the ones of both end portions of the second group of cables being secured on and along the first shaft portion to be opposed to each other in the rotation direction and the others of both end portions of the first group of cables and the others of both end portions of the second group of cables being secured on and along the second shaft portion to be opposed to each other in the rotation direction.

18. The robot of claim 15, wherein the first cable guide is structured by two plate members formed to have the circular tube-shaped space having a U-shaped section whose one end opposed to the second shaft portion is opened and the second cable guide is structured by two plate members formed to have the circular tube-shaped space having a unshaped section whose one end opposed to the first shaft portion is opened, the U-shaped section being viewed along a radial direction of the rotary shaft portion.
